(19) United States
(12) Patent Application Publication
(10) Pub. No.: US 2013/0116887 A1
(43) Pub. Date: May 9, 2013

(54) VEHICLE CAMERA SYSTEM WITH REPLAY

(71) Applicants: CRAIG A. TIEMAN, WESTFIELD, IN (US); MICHAEL E. MILLER, ROSSVILLE, IN (US)

(72) Inventors: CRAIG A. TIEMAN, WESTFIELD, IN (US); MICHAEL E. MILLER, ROSSVILLE, IN (US)

(73) Assignee: DELPHI TECHNOLOGIES, INC., TROY, MI (US)

(21) Appl. No.: 13/291,258

(22) Filed: Nov. 8, 2011

(51) Int. Cl. G06F 17/00

(52) U.S. Cl. 701/36

(57) ABSTRACT

A system, controller, and method for displaying an image corresponding to a field of view about a vehicle. The controller stores images from a camera, and outputs a processed signal to display to a vehicle operator stored images from a time period prior to the controller receiving an operator input signal. A vehicle equipped so will allow a vehicle operator actuate the operator input device in order to review images and thereby verify that another vehicle or a pedestrian has moved away from the vehicle.

### TECHNICAL FIELD OF INVENTION

This disclosure generally relates to a camera system showing a field of view about a vehicle, and more particularly relates to a way to display an image from a prior time in response to a request to replay the image.

BACKGROUND OF INVENTION

It is known to equip vehicles with a camera for displaying a field of view about the vehicle that is not easily seen with periphery vision or by using conventional rearview and sideview mirrors. It is also known to equip vehicles with detection systems (e.g. radar or ultrasonic detection systems) that alert a vehicle operator to the presence of an object in close proximity to the vehicle. Alerts from such a system may be in the form of an audible sound, an illuminated indicator, or both. However, once such an alert is issued, it is left to the vehicle operator to determine what may have caused the alert. For example, if a pedestrian walks behind the vehicle while the vehicle operator is looking elsewhere, and so the vehicle operator does not know that the pedestrian passed behind the vehicle and is now away from the vehicle, but a detection system issued an alert, it may be difficult for the vehicle operator to determine what caused the alert to be issued.

### SUMMARY OF THE INVENTION

In accordance with one embodiment, a system for displaying an image corresponding to a field of view about a vehicle is provided. The system includes a camera, a controller, an operator input device, and a display. The camera is configured to be mounted on a vehicle and output a video signal indicative of a field of view about the vehicle. The controller is configured to receive the video signal, store the video signal in memory as stored images, and process the stored images to output a processed signal for display to a vehicle operator. The operator input device is coupled to the controller and is configured to be actuated by the vehicle operator to provide an operator input signal to the controller. The display is configured to receive the processed signal from the controller and display an image corresponding to the processed signal. The processed signal output by the controller in response to the operator input signal corresponds to stored images from a time period prior to the controller receiving the operator input signal.

In another embodiment, a controller for a system for displaying an image corresponding to a field of view about a vehicle is provided. The system includes a camera configured to be mounted on a vehicle and output a video signal indicative of a field of view about the vehicle to the controller, an operator input device coupled to the controller and configured to be actuated by the vehicle operator to provide an operator input signal to the controller, and a display configured to receive a processed signal from the controller and display an image corresponding to the processed signal. The controller includes a video signal input, a memory, and a processor. The video signal input is configured to receive the video signal. The memory is configured to store the video signal as stored images. The processor is configured to process the stored images to output a processed signal for display to a vehicle operator. The processed signal output by the controller in response to the operator input signal corresponds to stored images from a time period prior to the controller receiving the operator input signal.

In yet another embodiment, a method for displaying an image corresponding to a field of view about a vehicle is provided. The method includes receiving a video signal from a camera configured to be mounted on a vehicle in a manner effective to observe a field of view about the vehicle. The method also includes storing the video signal as stored images; detecting an input signal from an operator input device to replay a stored image. The method also includes processing the stored images in response to the operator input signal to output a processed signal to a display that corresponds to stored images from a time period prior to the controller receiving the operator input signal.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is top view of a vehicle equipped with a camera system in accordance with one embodiment;

FIG. 2 is a perspective view of a vehicle interior of the vehicle in FIG. 1 in accordance with one embodiment;

FIG. 3A-3F are images stored by the camera system of FIG. 1 in accordance with one embodiment;

FIG. 4 is a composite image of images shown in FIG. 3A-3F in accordance with one embodiment; and

FIG. 5 is a flowchart for operating the camera system of FIG. 1 in accordance with one embodiment.

### DETAILED DESCRIPTION

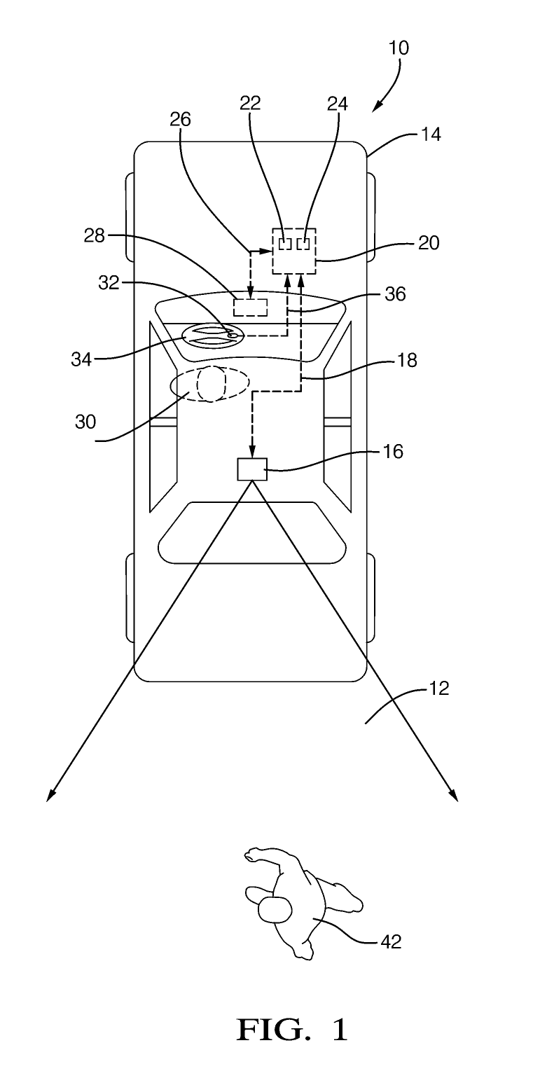

FIG. 1 illustrates a non-limiting example of a system 10 for displaying an image corresponding to a field of view 12 about a vehicle 14. In this example the vehicle 14 is an automobile, however it is contemplated that the system 10 may also be useful installed on other vehicles such as off-road construction equipment. The field of view 12 is illustrated as being behind the vehicle 14; however it is contemplated that the system 10 may also be useful if the field of view was an area beside the vehicle 14.

The system 10 may include a camera 16 configured to be mounted on the vehicle 14. In this example, the camera 16 is mounted on the roof of the vehicle and oriented to be able to capture images of the field of view 12. Alternatively, the camera 16 may be mounted on the rear deck (i.e. trunk lid) or rear bumper of the vehicle 14 for a field of view behind the vehicle, or may be mounted on elsewhere to observe a field of view beside the vehicle, for example by mounting the camera on a side view mirror assembly. The camera is generally configured to output a video signal 18 indicative of a field of view about the vehicle 14. The video signal may have a frame rate suitable for viewing continuous motion, thirty frames per second for example. Alternatively, the camera 16 may have a reduced frame rate such as two frames per second in order to reduce the cost of the camera 16. The usefulness of a reduced frame rate camera will become apparent in the discussion that follows.

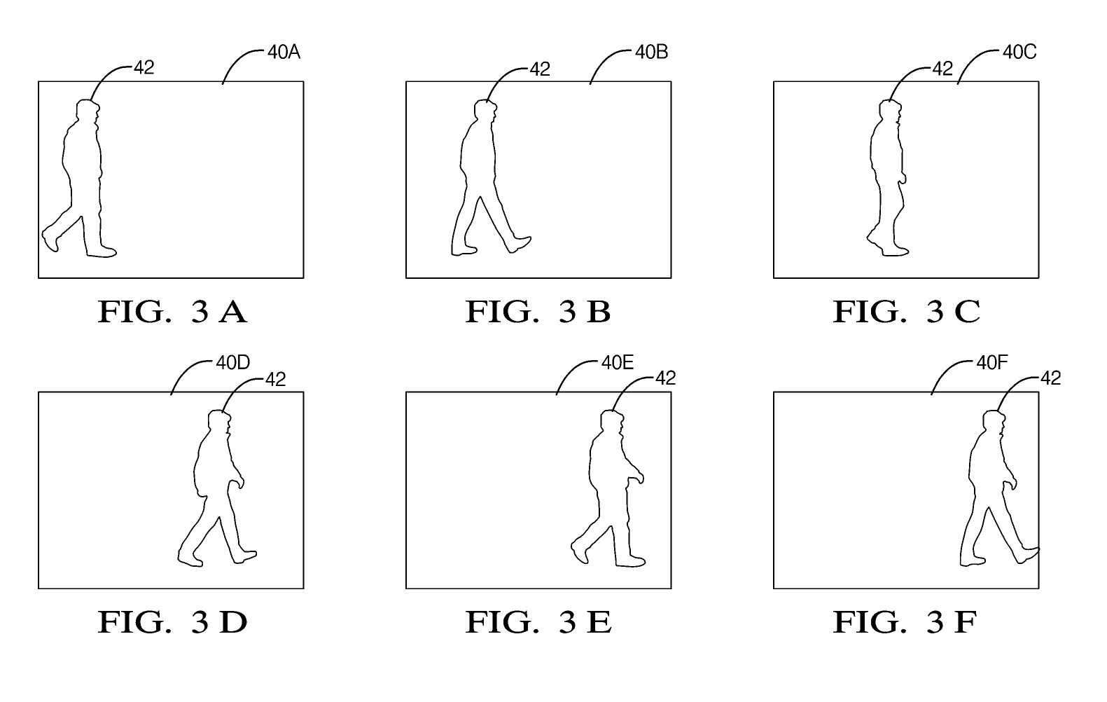

The system 10 may include a controller 20 configured to receive the video signal 18. The controller 20 may include a processor 22 such as a microprocessor or other control circuitry as should be evident to those in the art. The controller 20 may include memory 24, such as electrically erasable programmable read-only memory (EEPROM) for storing one or more routines, and storing the video signal as, for example, a series of stored images 40A-40F (FIG. 3). The one or more routines may be executed by the processor 22 to perform steps for processing the stored images 40A-40F in order to output a processed signal 26 to a display 28 for display to a vehicle operator 30.

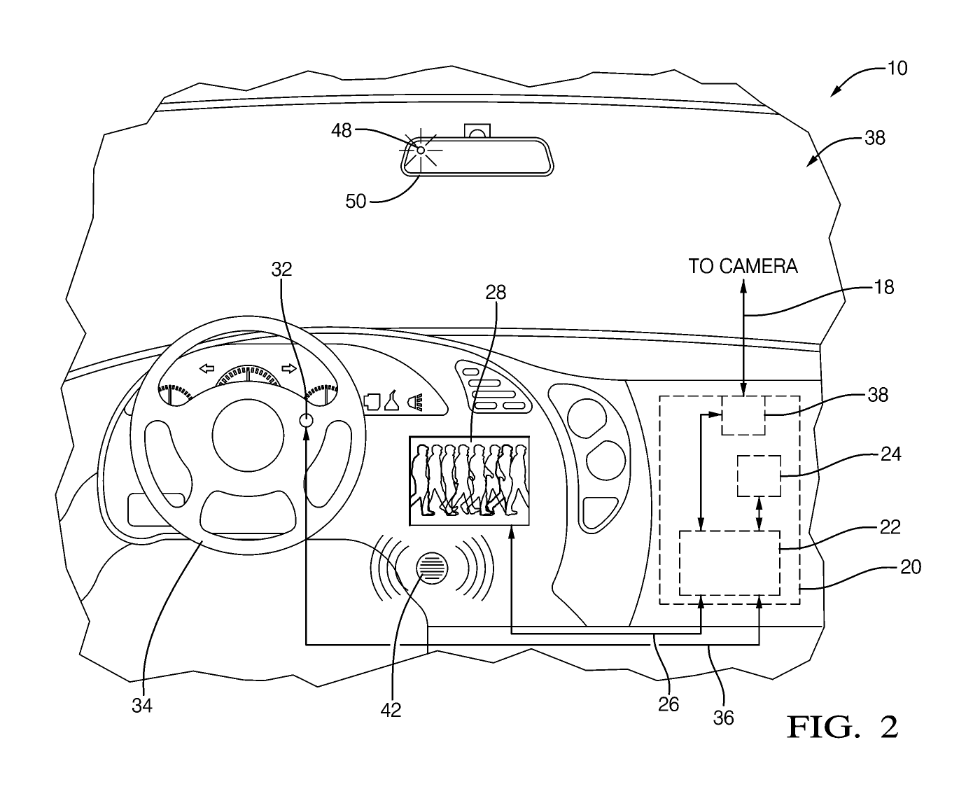

The system 10 may include an operator input device 32 (FIG. 2) configured to be actuated by the vehicle operator 30, such as a pushbutton on a steering wheel 34, or a touch sensitive spot on a turn signal lever (not shown). The operator input device 32 may be coupled to the controller 20 to provide an operator input signal 36 to the controller 20.

FIG. 2 illustrates a non-limiting example of the display 28 installed into a vehicle interior 28 configured to receive the processed signal 26 from the controller 20 and display an image corresponding to the processed signal 26. As will be explained in more detail below by way of examples, the processed signal 26 output by the controller 20 in response to the operator input signal 36 generally corresponds to stored images 40A-40F from a time period prior to the controller 20 receiving the operator input signal.

FIGS. 3A-3F illustrates non-limiting examples of stored images 40A-40F of a pedestrian 42 walking behind the vehicle 14. If the camera 16 has a frame rate of thirty frames per second, then the stored images 40A-40F may be by way of a periodic selection of all of the images stored in the memory 24. For example, the stored images 40A-40F may be a selection of every fifteenth image stored in the memory 24, and so may correspond to images taken every half second. Alternatively, if the camera 16 has a frame rate of two frames per second, the stored images 40A-40F may correspond to every image captured by the camera 16. In either case, the processed signal 26 generally corresponds to a plurality of periodically selected stored images. For example, in response to receiving the operator input signal 36, the controller may simply replay stored images from the previous five seconds of images stored in the memory 24.

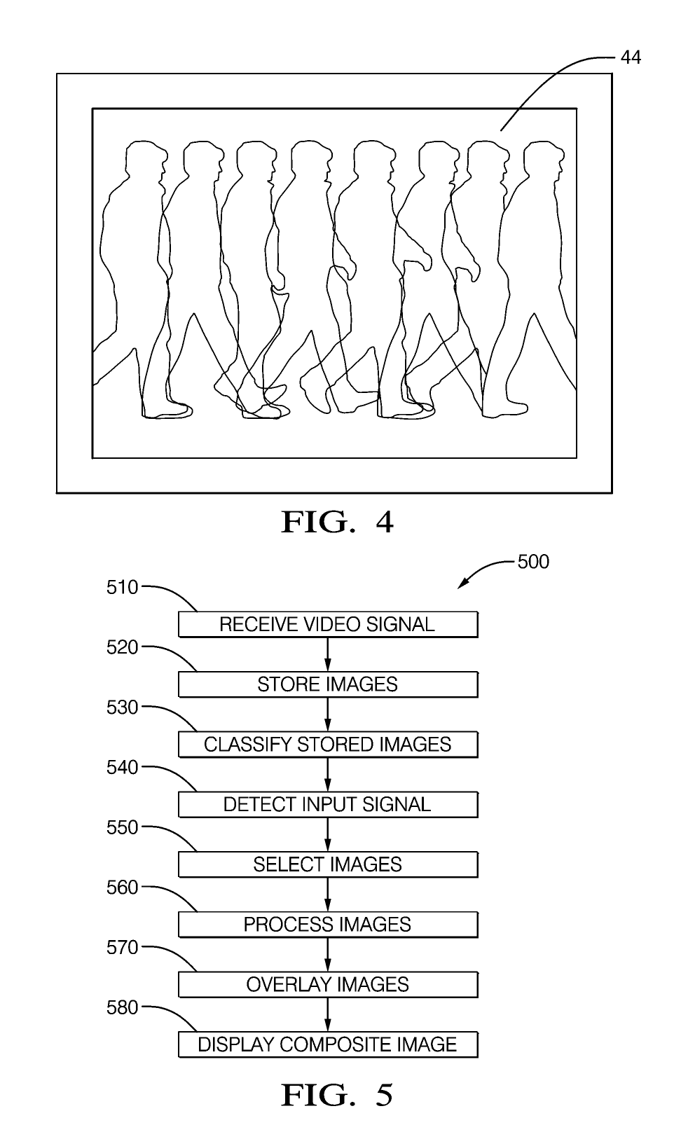

FIG. 4 illustrates a non-limiting example of the stored images 40A-40F overlaid to form a composite image 44. In order to form the composite image 44, it may be preferable to classify the images stored in memory 24 from oldest to most recent in accordance to an order that the stored images 40A-40F were received by the controller 20. In an embodiment, the composite image 44 may include a first stored image (e.g. stored image 40B) and a second stored image (e.g. stored image 40D) classified as more recent than the first stored image are processed by the controller 20 or processor 22 such that the first stored image is displayed in the composite image 44 with greater transparency (i.e. more transparent) than the second stored image. By overlaying the stored images 40A-40F with varying degrees of transparency, the vehicle operator 30 can readily discern which of the stored images 40A-40F is the oldest, and which is the most recent.

In one embodiment, the composite image 44 may correspond to a moving replay of a number of periodically selected stored images, where an oldest displayed image in the composite image 44 is replaced by a most recent image retrieved image from memory. For example, this moving replay may start with the composite image 44 showing only stored image 40A, and then later adding stored image 40B to the composite image 44, and so on until when stored image 40E is added to the composite image 44, the stored image 40A is removed from the composite image. This may be by way of an evident removal of stored image 40A, or by way of increasing the transparency of stored image 40A as each of the stored images 40B-40E are added so that stored image 40A appears to fade away from the composite image 44. As such, for this example, FIG. 4 may be interpreted to illustrate a snapshot of the display 28 after several of the stored images 40A-40F has been added to the composite image 44.

In another embodiment, the composite image 44 may be a still image formed of a predetermined number of the periodically selected stored images. In the example given above where the composite image is moving, FIG. 4 illustrates a snapshot of the display 28. In this example of a still image, FIG. 4 can be interpreted to illustrate a still image that is displayed for a period of time, five seconds for example.

In another embodiment, the controller 20 may be configured to extract a moving portion 52 (FIG. 4) of the stored images 40A-40F, for example the pedestrian 42, that may be characterized as moving relative to a background portion 54 of the stored images 40A-40F. Extracting a moving object from an image may be by motion flow analysis of the stored images 40A-40F or by other means known to those skilled in the art. By extracting the moving portion 52 and overlaying the moving portion on a single image of the background portion 54, the composite image 44 may be easier for the vehicle operator 30 to interpret since the background would appear fixed, even though, for example, the vehicle was backing out of a parking space causing the background portion 54 to vary.

Referring again to FIGS. 1-3 to summarize, the controller 20 for the system 10 may include a video signal input 38 configured to receive the video signal 18, a memory 24 configured to store the video signal 18 as stored images 40A-40F, and a processor 22 configured to process the stored images 40A-40F to output a processed signal 26 for display to a vehicle operator 30. The processed signal 26 output by the controller 20 or processor 22 in response to the operator input signal 36 may correspond to stored images 40A-40F from a time period prior to the controller 20 receiving the operator input signal 36.

By way of an example, and not limitation, the vehicle 14 may be equipped with an object detection device capable to detect a pedestrian 42 walking behind the vehicle 14 and activate an audible alarm 46, and/or illuminates an indicator 48 in response to detecting the pedestrian 42. If the vehicle operator 30 shifts the vehicle 14 into reverse gear and thereby activates the object detection device, and the object detection device activates the audible alarm 46 and/or the indicator 48 because a pedestrian 42 passed behind the vehicle, but because the vehicle operator 30 was distracted, he failed to see the pedestrian 42 in the review minor 50, the vehicle operator 30 can actuate an operator input device 32 to replay the stored images 40A-40F in the form of a composite image 44 in one of the several manners described above.

FIG. 5 illustrates a method 500 for displaying an image corresponding to a field of view 12 about a vehicle 14.

Step 510, RECEIVE VIDEO SIGNAL, may include receiving a video signal 18 from a camera 16 configured to be mounted on the vehicle 14 in a manner effective to observe a field of view 12 about the vehicle 14. The video signal 18 may be communicated to the controller 20 by way of a wire or by a wireless communication link known to those skilled in the art.

Step 520, STORE IMAGES, may include storing the video signal 18 as stored images 40A-40F. The controller 20 or processor 22 may store every image received from the camera 16, or may periodically select images for storage, for example only store an image every half second, even if the video signal 18 includes thirty images (frames) per second.

Step 530, CLASSIFY STORED IMAGES, may include classifying the stored images 40A-40F from oldest to most recent in accordance to an order that the stored images 40A-40F were received by the controller 20. As memory 24 becomes full, the oldest images may be deleted to make room for more recent images.

Step 540, DETECT INPUT SIGNAL, may include detecting an operator input signal 36 from an operator input device 32 to replay a stored image.

Step 550, SELECT IMAGES, may include retrieving stored images from memory 24, either every image stored, or selecting certain images.

Step 560, PROCESS IMAGES, may include processing the stored images in response to the operator input signal 36 to output a processed signal 26 to a display 28 that corresponds to stored images from a time period prior to the controller 20 receiving the operator input signal 36. For example, processing the stored images may include changing the apparent transparency of each image according to the age of the image so that the older images appear more transparent that more recent images. Changing the transparency of an image may be by way of proportionally reducing an intensity value of each pixel in the image so that when the image is combined with or overlaid by other images, the image with reduced pixel intensity appears to be transparent relative to other images in the composite image 44. Further processing may include extracting a moving portion 52 of the stored images 40A-40F 54 characterized as moving relative to a background portion of the stored images 40A-40F.

Step 570, OVERLAY IMAGES, may include overlaying a first stored image (40B) and a second stored image (40E) classified as more recent than the first stored image. Following Step 560, overlaying images is such that the first stored image is displayed in the composite image 44 with greater transparency that the second stored image.

Step 580, DISPLAY COMPOSITE IMAGE, may include displaying a composite image 44 that corresponds to a moving replay of a number of periodically selected stored images, wherein an oldest displayed image in the composite image 44 is replaced by a most recent image retrieved image from memory. Alternatively, the composite image 44 may correspond to a still image comprising a predetermined number of the periodically selected stored images.

Accordingly, a system 10, a controller 20 for the system 10 and a method 500 of displaying or replaying an image corresponding to a field of view about a vehicle is provided. A vehicle equipped so will allow a vehicle operator 30 actuate the operator input device 32 in order to review images in order to, for example, verify that another vehicle or a pedestrian 42 has moved away from the vehicle 14. Alternatively, the vehicle operator 30 may double check why an object detection device capable to detect a pedestrian 42 walking behind the vehicle 14 has activated an audible alarm 46 and or an indicator 48.

While this invention has been described in terms of the preferred embodiments thereof, it is not intended to be so limited, but rather only to the extent set forth in the claims that follow.

We claim:

1. A system for displaying an image corresponding to a field of view about a vehicle, said system comprising:
a camera configured to be mounted on a vehicle and output a video signal indicative of a field of view about the vehicle;
a controller configured to receive the video signal, store the video signal in memory as stored images, and process the stored images to output a processed signal for display to a vehicle operator;
an operator input device coupled to the controller and configured to be actuated by the vehicle operator to provide an operator input signal to the controller; and
a display configured to receive the processed signal from the controller and display an image corresponding to the processed signal, wherein the processed signal output by the controller in response to the operator input signal corresponds to stored images from a time period prior to the controller receiving the operator input signal.

2. The system in accordance with claim 1, wherein the processed signal corresponds to a plurality of periodically selected stored images overlaid to form a composite image.

3. The system in accordance with claim 2, wherein the stored images are classified from oldest to most recent in accordance to an order that the stored images were received by the controller, wherein a first stored image and a second stored image classified as more recent than the first stored image are processed such that the first stored image is displayed in the composite image with greater transparency that the second stored image.

4. The system in accordance with claim 3, wherein the composite image corresponds to a moving replay of a number of periodically selected stored images, wherein an oldest displayed image in the composite image is replaced by a most recent image retrieved image from memory.

5. The system in accordance with claim 3, wherein the composite image corresponds to a still image comprising a predetermined number of the periodically selected stored images.

6. The system in accordance with claim 3, wherein the controller is further configured to extract a moving portion of the stored images characterized as moving relative to a background portion of the stored images.

7. A controller for a system for displaying an image corresponding to a field of view about a vehicle, said system comprising a camera configured to be mounted on a vehicle and output a video signal indicative of a field of view about the vehicle to the controller, an operator input device coupled to the controller and configured to be actuated by the vehicle operator to provide an operator input signal to the controller, and a display configured to receive a processed signal from the controller and display an image corresponding to the processed signal, said controller comprising:
a video signal input configured to receive the video signal;
a memory configured to store the video signal as stored images; and
a processor configured to process the stored images to output a processed signal for display to a vehicle operator, wherein the processed signal output by the controller in response to the operator input signal corresponds to stored images from a time period prior to the controller receiving the operator input signal.

8. The controller in accordance with claim 7, wherein the processed signal corresponds to a plurality of periodically selected stored images overlaid to form a composite image.

9. The controller in accordance with claim 8, wherein the stored images are classified from oldest to most recent in accordance to an order that the stored images were received by the controller, wherein a first stored image and a second stored image classified as more recent than the first stored image are processed such that the first stored image is displayed in the composite image with greater transparency that the second stored image.

10. The controller in accordance with claim 9, wherein the composite image corresponds to a moving replay of a number of periodically selected stored images, wherein an oldest displayed image in the composite image is replaced by a most recent image retrieved image from memory.

11. The controller in accordance with claim 9, wherein the composite image corresponds to a still image comprising a predetermined number of the periodically selected stored images.

12. The controller in accordance with claim 9, wherein the controller is further configured to extract a moving portion of the stored images characterized as moving relative to a background portion of the stored images.

13. A method for displaying an image corresponding to a field of view about a vehicle, said system comprising:
receiving a video signal from a camera configured to be mounted on a vehicle in a manner effective to observe a field of view about the vehicle;
storing the video signal as stored images;
detecting an input signal from an operator input device to replay a stored image;
processing the stored images in response to the operator input signal to output a processed signal to a display that corresponds to stored images from a time period prior to the controller receiving the operator input signal.

14. The method in accordance with claim 13, wherein the step of processing includes periodically selecting stored images and overlaying those images to form a composite image.

15. The method in accordance with claim 13, said method further comprising classifying the stored images from oldest to most recent in accordance to an order that the stored images were received by the controller.

16. The method in accordance with claim 15, wherein the step of processing includes overlaying a first stored image and a second stored image classified as more recent than the first stored image such that the first stored image is displayed in the composite image with greater transparency that the second stored image.

17. The method in accordance with claim 16, wherein the composite image corresponds to a moving replay of a number of periodically selected stored images, wherein an oldest displayed image in the composite image is replaced by a most recent image retrieved image from memory.

18. The method in accordance with claim 16, wherein the composite image corresponds to a still image comprising a predetermined number of the periodically selected stored images.

19. The method in accordance with claim 15, wherein processing includes extracting a moving portion of the stored images characterized as moving relative to a background portion of the stored images.
